(19) United States
(12) Patent Application Publication
(10) Pub. No.: US 2003/0186727 A1
(43) Pub. Date: Oct. 2, 2003

(54) Cellular communication handset device

(76) Inventor: Asaf Gurner, Tel Aviv (IL)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/420,412

(22) Filed: Apr. 22, 2003

Related U.S. Application Data
(63) Continuation-in-part of application No. 09/638,760, filed on Aug. 15, 2000, now abandoned.

(30) Foreign Application Priority Data
Jun. 29, 2000 (IL) 137080

(51) Int. Cl. H04M 1/00

(52) U.S. Cl. 455/575.1; 455/74.1; 455/90.3

(57) ABSTRACT

A communication device configured in such a manner that the cellular communication device antenna and circuitry may be situated at a distance from the user during use. High frequency, electromagnetic radiation emitted from the antenna is thereby substantially diminished by the time it reaches the user. The device may include a handset unit, a speaker, a microphone and a connecting cord. Th device may also include a desktop base unit such as a conventional telephone base unit on which a cellular communication device is situated. The handset unit may comprise a conventional headset unit, such as a cellular telephone hands-free headset unit, inside conventional handset housing.

### BACKGROUND OF THE INVENTION

1. Field of the Invention

The present invention relates generally to communication devices and, more particularly, to a wireless communication device, that protects the operator of the device by substantially reducing the intensity of high frequency long-range electromagnetic radiation to which the operator is exposed in the course of the phone calls while offering enhanced comfort in handling.

2. Discussion of the Related Art

Hand-held, portable cellular devices are small, lightweight units, such as telephone devices and the like which do not require hardwired connection with a telephone or other communication switching exchange but communicate via a network of transmitting/receiving stations via radio-frequency transmissions. In recent years following advances in electronics and following the establishment and rapid expansion of a far ranging wireless transmission network, hand-held portable cellular devices became very popular. Despite drawbacks such as poor sound and transmission quality as compared with conventional telephones the number of hand-held portable wireless subscribers had grown substantially. There are well over two hundred million hand-held portable cellular users worldwide where some users own more than one device.

Lately concerns are being expressed regarding the use of wireless communication devices such as cellular telephones. In particular, it has been asserted that the high-frequency long-range electromagnetic radiation emitted from the antenna of cellular telephone devices and other wireless communication devices may be an effective factor to a number of radiation-related diseases such as cancer. Due to the close proximity of the cellular communication circuitry and cellular antenna to the head of the user during operation of the telephone, the intensity of the electromagnetic radiation to which the user's head is exposed is quite high. As a result, an increasing number of concerned individuals are refraining from using hand-held cellular devices.

In an effort to reduce exposure to electromagnetic radiation from cellular telephones, various shielding devices have been developed designed to reflect radiation emission from the wireless devices, such as cellular telephones to a direction away from the user's body. However, these shielding devices have several drawbacks. For example, such shielding devices are not entirely effective in protecting the cellular telephone user from electromagnetic radiation emissions at close range since a certain degree of leakage generally occurs even from a shielded antenna. Attempts have also been made to provide shielding devices, which direct the electromagnetic radiation emissions from a non-directional antenna to a desired direction away from the user's head. However, such devices generally adversely affect the performance of the cellular telephone due to the resulting highly directional nature of the electromagnetic radiation.

A different approach for the solution of the problem has been pursued by the development of diverse cellular communications and phone-related devices designed in order to distance the antenna of the cellular device from the user to a distance which is sufficient such that the intensity of the electromagnetic radiation emitted is substantially attenuated by virtue of its passage through the air by the time it reaches and is incident on the user. Most said devices involve the utilization of a communications headset apparatus modularly connectable to the existing cellular communication device. Typically, the headset apparatus comprises a wiring harness, a control circuitry, operating switches, a microphone, a mouthpiece, and at least one earphone inserted into the user ear cavity. By arranging the headset/microphone unit on the user's head, it is possible to operate the communication device, in conjunction with the hand-held main cellular communication device unit, such as a cellular telephone.

However, the suggested devices have a number of disadvantages. For example, most users find the headset/microphone apparatus inconvenient to use, difficult to operate, cumbersome to carry, and socially unsuitable to wear under certain circumstances such as indoors, at private homes, or in offices, locations notable in respect to abundant utilization of cellular phones.

As a result of the close contact of the headset with sensitive parts of the human head increased perspiration is effected. Therefore, the apparatus is markedly inconvenient to use in the intemperate zones of the globe where temperatures and humidity are tending to be high.

Therefore, there is need for an improved wireless communication device, such as a cellular telephone, that addresses problems related to excessive radiation that might be harmful to the users, physical discomfort to the users, inconvenience, and lack of privacy.

### SUMMARY OF THE PRESENT INVENTION

One aspect of the present invention regards a communication device that consists of a handset unit to provide suitable housing to a speaker and a microphone, a speaker, a microphone, and a connecting cord connected to a cellular communication device such as a cellular phone.

A second aspect of the present invention regards an improved cellular communication device that consists of a handset unit to provide suitable housing to a speaker and a microphone, a cellular communication device headset unit embedded into or integrated with the communication device handset unit. The device configured in the above manner enables a user of the device to distance the handset unit from the cellular communication device during the reception and transmission of electromagnetic signals in order to reduce the intensity of radiation emitted from the antenna and the circuitry of the communication device.

A third aspect of the present invention regards a communication device that consists of a cellular communication transceiver unit to receive and transmit communication calls, a communication handset unit to provide suitable housing to a communication headset unit, a communication headset unit embedded into and integrated with said communication handset unit and coupled to said cellular communication unit, and a connecting cord to link said cellular communication unit to said communication headset unit. The above configuration enables the user to utilize the device in a portable manner.

A fourth aspect of the present invention regards a cellular communication device that consists of a communication handset unit to provide suitable housing to a cellular communication transceiver unit, and a cellular communication transceiver unit to receive and transmit communication calls.

Each and every aspect of the present invention provides substantial reduction of the accidental radiation emitted by the antenna and circuitry of the cellular communication unit and incidental on the user body parts.

Each and every aspect of the present invention provides substantially greater comfort to the user when using the proposed device.

Each and every aspect of the present invention offers enhanced ease of use of the proposed device.

### BRIEF DESCRIPTION OF THE DRAWINGS

A more complete appreciation of the present invention and many of the attendant advantages thereof will be understood by reference to the following detailed description when considered in connection with the accompanying drawings, in which

FIGS. 1A and 1B are perspective views of the cellular telephone handset device in accordance with a preferred embodiment of the present invention;

FIG. 2 is an exploded isometric view of the cellular telephone handset in accordance with the present invention;

FIG. 3A is a cross sectional view of the cellular telephone handset in accordance with the present invention;

FIG. 3B is a partial cross sectional view of the cellular telephone handset in accordance with the present invention.

### DETAILED DESCRIPTION OF THE PREFERRED EMBODIMENTS

The present invention overcomes the disadvantages of the prior art by providing a novel cellular communication device handset device that substantially reduces the exposure of a user to the electromagnetic radiation emitted by the conventional cellular communication device, provides enhanced comfort, and ease of use.

In the present document the telephone communication device is used hereto from as an example communication device contemplated by the present invention as one embodiment. It will be understood by those skilled in the art that the present invention can be applied to any kind of communication device, cellular or otherwise. It will be further understood and appreciated that the use of the term telephone is used for the purpose of illustration rather than limitation and that other communication devices are contemplated by the present invention.

The proposed device is configured by the modular connection of four distinct components into an operative package: a) a conventional cellular telephone, b) a conventional cellular telephone headset and associated connecting cord, c) a modified conventional telephone handset, d) a modified conventional telephone base. The advantage of the configuration lies in the combination of the most successful, highly dependable, long established, and widely accepted components. The components are combined into an efficient configuration in such a manner that a synergetic effect is achieved as the components' positive characteristics are supportive in regard to the other components flaws. Thus, the characteristic radiation-related drawback of the conventional cellular phone will be substantially reduced by the use of the conventional handset. In the same manner the disadvantages of the cellular headset such as general discomfort, inconvenience in use, and lack of privacy will be greatly reduced by the use of the conventional telephone handset. Historically, the classical telephone handset unit as the traditional interface to most telephone systems has been proved as the most preferred solution among the diverse alternative interfaces. The handset is extremely well known and practically the standard device used all around the globe. Therefore, it is easily perceived that practically all the potential customers will readily accept the utilization of the handset as part of the proposed apparatus. Additionally, as the handset is only in loose contact with the sensitive parts of the human head the heat and perspiration related problems would be greatly reduced. Subsequently the proposed apparatus will substantially attenuate the discomfort effected by higher than average ambient temperatures and/or by excessive atmospheric humidity. The cellular phone handset device designed to be functioning in two distinct modes of operation: a) a linked mode, and b) a detached mode. In the linked mode all the components in the package function coincidentally where the cellular phone is connected to the cellular handset via a connecting cord. When a call is made to the cellular phone the signals received by the cellular antenna are sent through the connecting cord to the cellular headset that is embedded into and integrated with the cellular no-free-hands handset. In the operative linked mode, the user positions the handset in the recognized manner near the user's head such that the speaking cavity in front of the microphone is in the proximity of the user's mouth and the listening cavity in the front of the earphone is in loose contact with the user's ear. Using the cellular handset thus has several advantages to the user: a) comfort, inasmuch as the need to use the conventional headset is eliminated, b) familiarity, as practically all users are accustomed to the use of the conventional telephone handset, and c) safety, since the use of the handset distances the user's head from the potentially harmful radiation emitted by the cellular antenna and the cellular telephone circuitry.

In the detached mode the cellular phone is used in the well-known standard manner which is independent of the other units in the configuration. In this manner the cellular phone is disconnected from the handset by the removal of the connecting cord. Consequently the signals received by the cellular antenna are conventionally routed to the microphone/earphone units of the cellular phone. In the following drawings like reference numbers designate identical or corresponding parts throughout the several views displayed.

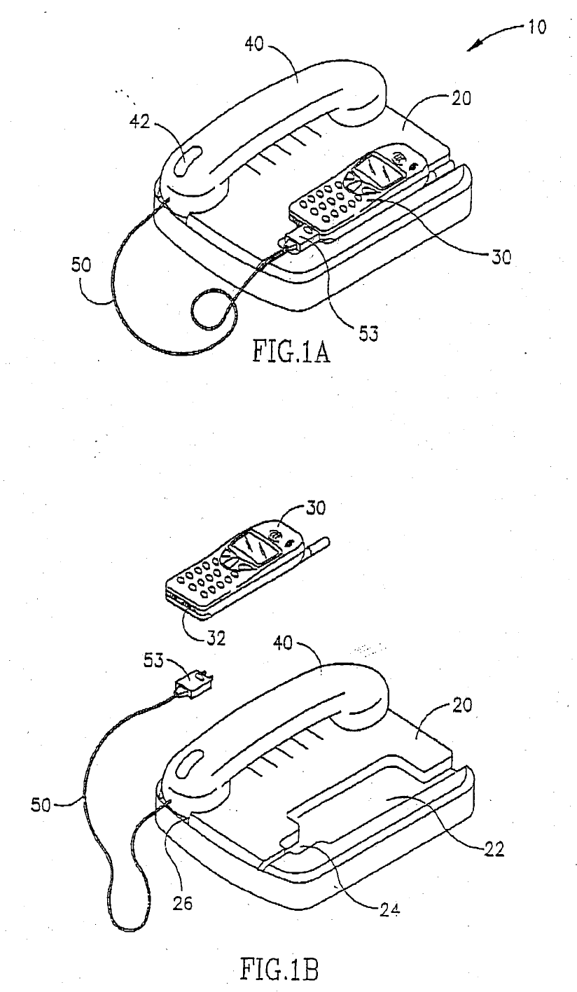

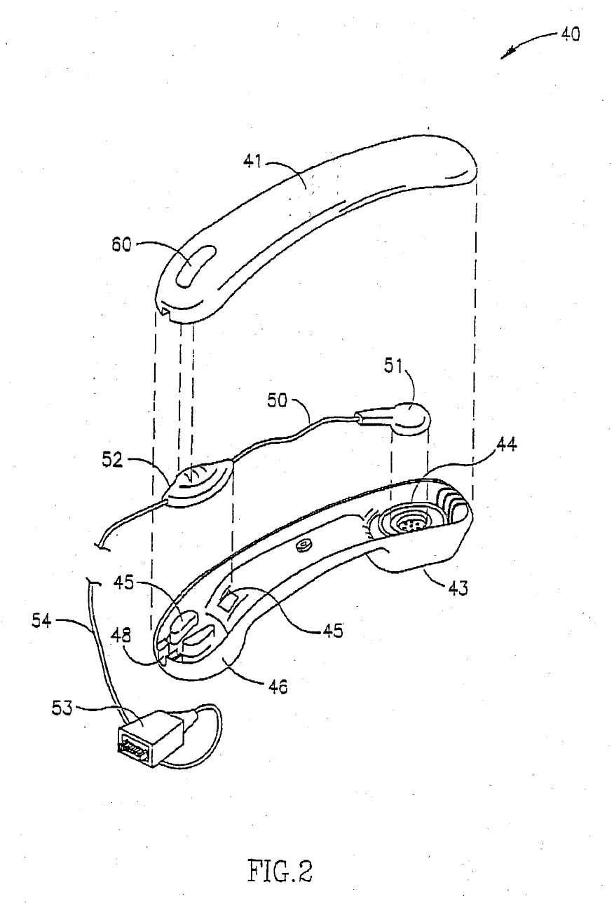

Referring now to FIG. 1A that shows a perspective view of the cellular telephone handset device 10 configured to a linked mode of operation. Cellular telephone handset device 10, according to a preferred embodiment of the invention, comprises a cellular handset unit 40 preferably having two members, an upper member 41 and a lower member 43 (further described in FIG. 2). Cellular telephone handset device 10 further comprises a speaker and a microphone, connected there between via a connecting cord. Said speaker and microphone may be connected together via a connecting cord using a variety of known components. For example, one known microphone and speaker connected together via a connecting cord may be the cellular phone headset unit 50 described in detail in FIG. 2. Similarly, the speaker and the microphone may comprise separate speaker and microphone components generally available on the market and a connecting cord capable of conveying the signals between the speaker and microphone and a communication device such as a telephone or a cellular telephone. The speaker and microphone may communicate with each other and with a communication device such as a cellular telephone via wireless means such as radio frequency protocols such as BLUETOOTH, infra red protocols, cellular protocols and other similar protocols.

Cellular telephone handset device 10, according to another preferred embodiment of the present invention, comprises a cellular phone handset device base unit 20, a conventional cellular phone unit 30, a cellular phone handset unit 40, and a cellular phone headset unit 50. To prevent accidental emission of radiation cellular phone headset unit 50 is suitably and effectively shielded against radiation and is embedded partially inside cellular phone handset unit 40. Headset unit 50 is connected by means of a flexible, elastic spring cord, and a suitable connector, such as the RJ-8 modular connector manufactured by Autosears Corporation of Stamford N.Y. USA, to an appropriate socket in cellular phone 30. In the linked mode when device 10 not in use, cellular phone unit 30 and cellular handset unit 40 are situated in suitably shaped and sized compartments on the surface of base unit 20. When a call is received to cellular phone unit 30 the user lifts the handset unit 40, and sets mechanical switch 42 to a suitable state in order to control the operation of the cellular phone unit. As a result the signals received during the call are routed from cellular phone unit 30 via connector 53, and connecting cord 54 to handset unit 40 accomplishing the desired communication by means of handset unit 40.

If the user call wishes to use cellular phone unit 30 without handset unit 40 then the connecting cord 54 should be disconnected from cellular phone unit 30. As a result the received signals will be routed in the conventional manner to the internal microphone/earphone of cellular phone unit 30. The user will lift the cellular unit 30 from base unit 20 and complete the call by means of cellular phone unit 30. In the detached mode of operation the handset unit 40 is not involved.

In the linked mode configuration the cellular phone unit 30 battery could be charged in the same manner the charging process is performed in detached mode. Thus, by connecting the cellular phone unit 30 situated on base unit 20 via a suitable socket, via a connector such as the T-150-P1 type connector manufactured by Ericsson Corporation of Stockholm, Sweden, and via a voltage transformer such as the 402-0036-BV-B type transformer manufactured by Ericsson Corporation of Stockholm, Sweden, to an electrical outlet, the charging of the battery will be accomplished.

Referring now to FIG. 1B that is shown a perspective view of the device 10 configured to operate in the detached mode. Device base unit 20 consists of cellular phone compartment 22, a cellular phone handset compartment 26, and an appropriate socket compartment 24 fitting to hold connector 53 to cellular phone unit 30. Cellular phone compartment 22 is adjustable in shape and size to make available the option of accommodating different types of cellular phones having different sizes or shapes. Typically, cellular phone unit 30 is situated within the cellular phone compartment 22 and cellular phone handset unit 40 is situated within the cellular phone handset compartment 26. In the detached mode of operation as shown on FIG. 1B cellular phone unit 30 is disconnected from handset unit 40 by the removal of connector 53 from socket 32. In the detached mode of operation cellular phone unit 30 operates independently of the other components of the configuration. It would be easily perceived that following the removal of cellular phone unit 30 from the device 10 another cellular phone unit could be connected therein.

The handset utilized could be the traditional telephone handset with only minor modifications or could be specifically manufactured so as to have specific form and predetermined dimensions in order to fit the proposed configuration.

In the preferred embodiment of the present invention, device 10 is designed to be used mainly indoors such as at the user's home or office or car as there is where the majority of calls are received. It would be easily perceived that in another embodiment of the present invention, device 10 could be readily adapted to a suitable portable configuration that will allow the attainment of calls outdoors.

Referring now to FIG. 2 showing an exploded isometric view of the cellular phone handset unit 40. The headset unit 50 comprises two sections. The first section comprises earphone 51, control box/microphone 52, and the wiring harness therebetween is embedded within an interior space created by attaching the upper member 41 of handset housing 40 to the lower member 43 of the handset housing 40 by means of mechanical pressure applied on both upper member 41 and lower member 43 towards one another. The second section of headset 50, comprising of connecting spring cord 54 and connector 53 is not embedded in the interior space of handset unit 40. The upper member 41 is preferably molded from a suitable plastic (e.g. ABS plastic) material and includes an opening for mechanical switch 60. The lower member 43 of the handset housing is preferably molded from a matching suitable plastic material, and consists of a listening cavity 44, a microphone cavity 46, a control box cavity 45, and an opening 48 intended to accommodate cellular phone connector 53. A conventional telephone handset housing could be used as the cellular phone handset 40 when said conventional handset housing would have to be modified in order to be enabled to hold additional members of cellular phone handset unit 40 such as the mechanical switch 42.

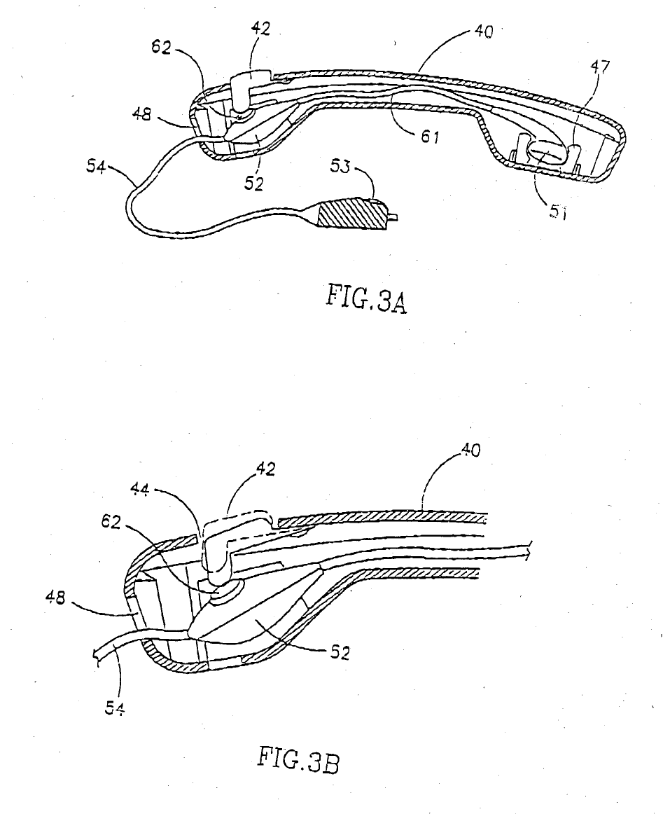

Referring now to FIG. 3A through FIG. 3B that are showing a cross sectional view of handset 40 and a partial cross sectional view of handset 40. The section of headset unit 50 is embedded and integrated within handset unit 50. Earphone 51 is situated in listening hole 44 and connected by wiring harness 61 to control box/microphone 52 that is situated in the microphone cavity 46. The microphone used could be any of the standard types such as the 1628-N-1 type carbon microphone manufactured by Audiosears Corporation of Stamford, N.Y. USA. Mechanical switch 42 is fitted into the mechanical switch opening 60 that is situated above micro-switch 62 of control box/microphone 52. Micro-switch 62 is designed to control the operation of cellular phone unit 30 of FIG. 1A. Control box/microphone 52 is connected via connecting cord 54 and via connector 53 to cellular phone unit 30 of FIG. 1A.

Mechanical switch 42 has two operative positions. When mechanical switch 42 is pushed down into a lower position as shown on FIG. 3B, physical contact is created between mechanical switch 42 and micro-switch 62 of the control box/microphone 52. As a result of the mechanical pressure therebetween, micro-switch 62 is activated. Therefore the cellular phone unit 30 is activated and the signals arriving/sent from/to the cellular antenna of cellular phone unit 30 of FIG. 1A are routed from/to the microphone/speaker of handset unit 40. Consequently, handset unit 40 becomes operative in the carrying out of the incoming and of outgoing calls.

It is seen from the foregoing that in the preferred embodiment of the present invention no electrical or mechanical modification of the existing cellular phone devices is required.

In another different embodiment of the present invention the proposed apparatus is used in a mobility-oriented configuration as a portable device. In this configuration no desktop base is involved. The cellular phone maintains loose physical contact with a modified traditional handset and linked operatively to the handset by a connecting cord. The device of such a configuration could be used as a mobile unit carried by the user. When the device is not in use the cord connecting the phone with the handset is rolled up on spring-loaded mechanical roller, which is kept in a rolled up position by the pressure of the spring. When the user wishes to place or accept a call, the user distances the handset unit from the cellular phone unit in the manner of pulling on the connecting cord in an outward direction against the pressure of the spring-loaded roller. Thereby the distancing of the cellular phone away from the handset is accomplished. On the termination of the call the user releases the outward-directed pressure. Subsequently, the connecting cord will roll up on the spring-loaded roller as a result of the circular movement of the spring-loaded roller effected by the spring pressure. Consequently the two main units of the device with create loose physical contact again. It would be easily perceived that in the mobile configuration the two units are detachable as well. It should be also clear to one skilled in the art that the above description was given as only as an example and should not be understood as a limitation to different other means and ways that could be used to flexibly distance the handset unit from the cellular unit.

It would be easily perceived that the above description was presented for the purpose of clarification only and was not intended as any kind of limitation. Different other embodiments based on the underlying concept of the present invention are contemplated within the scope of the following claims.

Persons skilled in the art will appreciate that the present invention is not limited to what has been particularly shown and described hereinabove. Rather the scope of the present invention is defined only by the claims, which follow.

I claim:

1. A communication device, comprising
a handset unit to provide suitable housing to a speaker and a microphone;
a speaker;
a microphone;
a connecting cord, and
a cellular phone connected to the handset unit thereby making available the option to a user to distance said handset unit from said cellular communication device during the reception and transmission of signals.

2. The communication device of claim 1 whereby the speaker and microphone are connected via the connecting cord.

3. The communication device of claim 1 whereby the speaker and microphone communicate therebetween via wireless means.

4. The communication device of claim 1 whereby the handset unit housing comprises an upper member and a lower member.

5. The communication device of claim 1 whereby the speaker and microphone are embedded within the handset unit.

6. The communication device of claim 1 whereby the speaker and microphone and connecting cord are embedded within the handset unit.

7. The communication device of claim 1 further comprising a mechanical switch responsive to a user of the device.

8. The communication device of claim 1 whereby the handset unit comprises:
an upper member;
a lower member;
a listening cavity, and
a microphone cavity.

9. A communication device, comprising
a handset unit to provide suitable housing to a speaker and a microphone;
a cellular communication device headset unit embedded into or integrated with said communication device handset unit;
thereby said configuration makes available the option to a user to distance said handset unit from said cellular communication device during the reception and transmission of electromagnetic signals in order to reduce the intensity of radiation emitted from the antenna and the circuitry of said communication device incidental on the user sensitive body parts.

10. The communication device of claim 9 further comprises a cellular communication device to receive and transmit calls via an antenna and via suitable electronic circuits;

11. The communication device of claim 9 wherein said speaker and said microphone are separate members integrated into said handset unit.

12. The communication device of claim 9 whereby the cellular communication device is a cellular telephone device.

13. The communication device of claim 9 further comprising a base unit to provide physical support to said cellular communication device and to said handset unit.

14. The communication device base unit of claim 10 comprising:
a compartment to adjustably hold said cellular communication device;
a handset compartment to adjustably hold said cellular communication device headset; and
a socket compartment to hold a suitable connector operative in the charging of the battery of said cellular communication device.

15. The communication device of claim 9 wherein said handset unit comprises:
an upper and lower covering members to provide for protection, insulation and convenient handling;
a listening cavity to provide housing to an earphone; and.
a microphone cavity to provide housing to a microphone.

16. The communication device of claim 9 wherein said handset unit further comprises:
a mechanical switch responsive to a user of the device to operate said cellular communication device headset;
a mechanical switch opening to provide suitable housing to a mechanical switch; and
a control box cavity to provide housing for a control box.

17. The communication device of claim 9 wherein said communication handset unit is a standard handset unit.

18. The communication device of claim 9 wherein said handset unit is a modified standard telephone like handset unit.

19. The communication device of claim 9 wherein said handset unit is a specifically manufactured handset unit.

20. The communication device of claim 9 wherein said cellular headset unit is embedded and integrated with into said handset unit.

21. The communication base unit of claim 13 wherein said cellular communication device compartment is adjustable to enable accommodation of diverse cellular communication devices and cellular telephone units.

22. The communication base unit of claim 13 wherein said cellular communication device compartment is configured to hold mechanical adapters to enable accommodation of diverse cellular communication devices or telephone units.

23. The communication base unit of claim 13 wherein said cellular communication device handset compartment is adjustable to enable accommodation of diverse handset units.

24. The communication base unit of claim 13 wherein said cellular communication device handset compartment is configured to accept mechanical adapters to enable accommodation of diverse handset units.

25. The communication device of claim 9 wherein said cellular communication device headset comprises:
an earphone to receive voice signals and output analog equivalents;
a control box to provide housing to a micro-switch and suitable control circuits;
a micro-switch responsive to mechanical pressure of said mechanical switch in order to operate said cellular communication device;
a microphone to receive analogue sound and output equivalent voice signals;
a wiring harness to connect electrically among the operative members of the headset unit; and
a connecting cord to link said cellular communication device to said communication device headset unit.

26. The communication device of claim 9 wherein said cellular communication device is linked to said headset unit via a connector and a connecting cord.

27. The communication device of claim 9 wherein said cellular communication device is detachable from said headset unit.

28. The communication device of claim 27, wherein detaching of said handset is operative in routing the received signals to the suitable earphone and the suitable microphone embedded in the cellular communication device.

29. The communication device of claim 9, wherein the handset unit is suitably shielded against accidental emission of electromagnetic radiation.

30. The communication device of claim 1, wherein the handset unit is suitably shielded against accidental emission of electromagnetic radiation.

31. A communication device, comprising:
a cellular communication transceiver unit to receive and transmit communication calls;
a communication handset unit to provide suitable housing to a speaker and a microphone;
a cellular communication headset unit embedded into or integrated with said communication handset unit and coupled to said cellular communication unit;
whereby said configuration makes available the option to a user to use said device in a mobile manner.

32. The communication device of claim 31, wherein the handset unit is suitably shielded against accidental emission of electromagnetic radiation.

33. The communication device of claim 31 further comprises a connecting cord to link said cellular communication device to said cellular handset unit.

34. The communication device of claim 33 wherein said connecting cord is a spring cord.

35. The communication device of claim 31 wherein said speaker and said microphone are members of an existing cellular communication headset unit.

36. A handset unit designed in the form of a communication device for accommodating cellular communication devices comprising:
a housing to provide for protection, insulation and convenient handling;
a listening cavity to provide housing to an earphone;
a microphone cavity to provide housing to a microphone;
thereby said configuration makes available the option of accommodating an embedded cellular communication headset device.

37. The handset unit of claim 36 wherein said housing comprises;
an upper member; and
a lower member.

38. The handset unit of claim 36 wherein said handset unit further comprises:
a mechanical switch responsive to a user of the device to operate said cellular communication device headset;
a mechanical switch opening to provide suitable housing to a mechanical switch; and
a control box cavity to provide housing for a control box.

39. The communication device of claim 36, wherein the handset unit is suitably shielded against accidental emission of electromagnetic radiation.
